(19) United States
(12) Patent Application Publication
(10) Pub. No.: US 2010/0129601 A1
(43) Pub. Date: May 27, 2010

(54) INSTALLATION FOR PRODUCING WEBS WITH STEMS AND WEBS WITH STEMS WHICH CAN BE OBTAINED THROUGH THIS INSTALLATION

(76) Inventors: Gwendaël Le Guelaff, Mesanger (FR); Alain Massaud, La Varenne (FR)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/452,483

(22) PCT Filed: Jul. 15, 2008
(86) PCT No.: PCT/FR2008/001029

§ 371 Date: Jan. 4, 2010

(30) Foreign Application Priority Data
Jul. 13, 2007 (FR) 0705083

(51) Int. Cl. B32B 38/06; B29C 59/04; B44C 1/22; B23H 5/08

(52) U.S. Cl. 428/120; 425/363; 425/174.4; 216/11; 205/663

(57) ABSTRACT

Web with stems constituted by a base strip and at least one stem projecting from the strip and forming part thereof, in particular being made of the same material as the strip, the at least one stem having a straight axis and a cross-section perpendicular to the straight axis which is constant or decreases from the base to the tip of the stem, characterised in that the at least one stem has a height measured along its axis and a width corresponding to its largest dimension measured parallel to the plane of the strip, the width being between 0.05 mm and 0.250 mm, and the ratio of the height of the stem to its width is at least greater than 2, preferably greater than or equal to 3.

The present invention relates to an installation for producing a web, particularly in the form of a strip, particularly of thermoplastic material, having one side from which stems project, particularly being of the same material as the strip, particularly forming part of the strip. The present invention also relates to a web, particularly in the form of a base strip, particularly of thermoplastic material, having one side from which stems project, particularly being of the same material as the strip, particularly forming part of the strip. The stems are not hooks. They have a straight longitudinal axis and a cross-section perpendicularly to this straight longitudinal axis which is constant or which decreases from the base to the tip of the stem.

An installation and a so-called moulding method are already known from the prior art for obtaining webs with stems of this type. In this installation and method of the prior art, a moulding roller is realised which comprises cavities of a complementary form to the stems which one wishes to obtain. Thermoplastic material is passed in a liquid or melted state onto the surface of the roller so that it is introduced into the cavities and, after cooling, a web having stems of a complementary form to that of the cavities is obtained on leaving the installation. The cavities in this installation and method of the prior art are formed by laser etching in a supple material such as rubber.

This method and installation of the prior art have the following drawback. By reason of the formation of the stems through moulding, and particularly by reason of the fact that it is necessary to extract these stems from their cavity after their formation in the cavities, it is not possible to obtain webs with stems of which the stems are fine and of great height.

For moulding cavities formed with certain dimensions, in particular the depth, once the thermoplastic material has been introduced and then extracted in the form of a stem normally in a complementary form to that of the cavity, stems are obtained with a height which is much smaller than the depth of the cavities from which they have been de-moulded. Besides, if it is sought to obtain fine stems of a conical form (“conical” in terms of the present application is understood to be a form of which the cross-section reduces towards a tip section), only cavities of a small depth can be realised. It is also difficult to obtain, at the outlet of the installation, stems which are all of a substantially identical height. Finally, a further drawback is that it is impossible, by reason of the manufacturing tolerances connected with laser etching, particularly in rubber, to obtain at the outlet of the installation webs with stems of which the stems are very close to each other at least in one direction.

It would be desirable to be able to obtain a web with stems of this type, that is to say having fine stems of a great height, preferably according to a manufacturing method which facilitates large-scale production.

According to the invention, a device for forming a web with stems having a base from which stems project which are made of a thermoplastic material and having a straight axis and of which the cross-section in a plane parallel to that of the base is constant or decreases from the base towards the tip of the web, comprising a moulding roller in which cavities are formed which are of a complementary form to that of the stems to be formed, is characterised in that the moulding roller is, at least in part, particularly in the form of a layer, made of a porous material with open pores, whereby the porosity is chosen so that air molecules can pass but molecules of thermoplastic material cannot, whereby the arrangement is such that said section of a porous material delimits each cavity at least partially, particularly a section at the bottom thereof.

Thus, by means of this porous material, air which in the systems of the prior art was trapped at the bottom of the cavity by the thermoplastic material which is introduced there in order to form the stem and prevented this material from reaching the bottom, made it impossible to obtain a stem that was both fine and of a great height.

According to a development of the invention, the moulding roller comprises at least one upper layer of a first material and one lower layer of a second material, whereby the first material can be hollowed out or machined, the second material is a porous material, the cavities being formed through hollowing-out or machining in the first material until it is flush with the second material which thus forms at least a section of the bottom.

According to a development of the invention, the lower layer is constituted by the outer surface (excluding the upper layer) of the roller itself, for example by the hub of the roller, which can be made of porous ceramic for example.

Thus, when the web with stems is formed by introducing thermoplastic material into the cavities, particularly with a fluidity index at the time of entry of the material into the cavity of between 9 and 150 g/10 min, this material is not “stopped” by the air which can escape through the porous material. As a result, the melted or liquid thermoplastic material, even in the case of very fine and/or very deep cavities, can reach the bottom of the cavity, and the stems obtained after extraction have dimensions substantially equal in height to the depth of the cavity.

According to an embodiment of the invention, the machining or hollowing-out is realised by laser etching, whereby the outer surface of the lower layer serves as a stop surface for the laser beam (for example using a laser with a periscopic finder, in which the laser beam is deactivated) (it receives in return, through reflection, too much energy) when it reaches the surface of the second material.

According to a preferred embodiment, the porosity is chosen in such a way that the pores have an equivalent diameter (diameter of the circular cross-section of the same cross-section as that of the pores) of less than 50 micrometres, particularly in such a way that it is between 10 and 40 micrometres.

According to a development of the invention, the cavities are formed through machining of the material by micro piercing, particularly of a layer of a plastic material, or by electro erosion, particularly of a layer of metallic material.

The combination of the use of the porous material and the machining through electro erosion or micro piercing allows stems to be obtained which are particularly fine and of great height, also with great reproducibility, whereby the final height of the stems corresponds to almost exactly that of the cavities.

Besides, the shape of the cavities can be selected at will. In particular, it is now possible to obtain stems with a cylindrical lower section and at least one upper section in the form of a cone, but with a great fineness and a great height of the stem.

According to a development, the device for forming a web with stems having at the outlet of the moulding roller a first thickness, a first length and a first width, comprises an upstream roller and a downstream roller which are disposed downstream of the moulding roller one after the other in the direction of the length (machine direction), whereby the downstream roller has a rotating speed greater than that of the upstream roller, the distance between the two rollers being small, in such a way that the web obtained at the outlet of the device has a second thickness which is smaller than the first thickness and a second length-which is greater than the first length. Besides, it has a width which is substantially identical to the first width, whereby the variation is small, the width going for example from 400 mm to 370 mm.

This device thus allows very fine stems of great heights to be obtained in combination with a very thin base, whereby this can be appreciable in the applications.

The downstream roller is preferably cold, that is to say at a temperature below the softening temperature of the stretched thermoplastic material, for example being in the order of 25° C., and the upstream roller is preferably hot, that is to say at a temperature which is equal to or greater than the softening temperature (Vicat softening point) of the thermoplastic material of the web.

It is thus possible to obtain, after the cold downstream roller, a strip of which the width varies only a little or not at all along its length. The variability of the width of the final strip is thus clearly improved with respect to the prior art.

The inter-roller distance is preferably equal to around one times the initial total thickness of the web with stems.

According to a preferred embodiment, the inter-roller distance is between 0.5 mm and 10 mm, for example between 0.7 mm and 3 mm.

According to an advantageous embodiment, the web with stems is subjected to heating on the side of the strip opposite the stems, prior to stretching.

The present invention therefore also aims to overcome the drawbacks of the prior art by proposing a web with stems which has very fine stems and which can be used in particular in combination with a fabric in order to obtain an anti-slip function which is particularly efficient between the web and the fabric without impairing the latter. In particular such webs with stems can be obtained very simply by the method and device according to the invention.

According to the invention, a web with stems is such as that defined in one of the claims 4 to 14.

According to an aspect of the invention, a web with stems is constituted by a strip and at least one stem projecting from the strip and forming part thereof, in particular being made of the same material as the strip, whereby the at least one stem has a straight axis and a cross-section perpendicular to the straight axis which is constant or decreases from the base to the tip of the stem, is characterised in that the at least one stem has a height measured along its axis and a width corresponding to its greatest dimension measured parallel to the plane of the strip, the width being between 0.05 mm and 0.250 mm, particularly between 0.071 mm and 0.250 mm, for example between 0.15 mm and 0.23 mm, more particularly between 0.071 mm and 0.185 mm, more preferably between 0.075 mm and 0.185 mm, and the ratio of the height of the stem to its width is at least greater than 2, preferably being greater than or equal to 3.

According to another form of the invention, a web with stems, constituted by a strip and at least one stem projecting from the strip and forming part thereof, in particular being of the same material as the strip, whereby the at least one stem has a straight axis and a cross-section perpendicular to the straight axis which is constant or decreases from the base to the tip of the stem, is characterised in that the at least one stem has a height measured along its axis and a width corresponding to its greatest dimension measured parallel to the plane of the strip, at least a tip section of the at least one stem is of conical form, and the ratio of the height of the stem to its width is at least greater than 2, preferably being greater than or equal to 3.

According to a development of the invention, the height of the at least one stem is between 0.2 mm and 0.8 mm, in particular between 0.3 mm and 0.8 mm, preferably between 0.4 mm and 0.6 mm.

Preferably, in this embodiment with conical form, the width of the at least one stem is between 0.05 mm and 0.250 mm, for example between 0.15 mm and 0.23 mm, particularly between 0.071 mm and 0.250 mm, more particularly between 0.075 mm and 0.250 mm, more preferably between 0.075 mm and 0.23 mm.

Preferably, the strip has a thickness measured in the direction of the axis of the at least one stem which is less than 0.1 mm, in particular being between 0.03 and 0.09 mm.

This combination of a strip with a small thickness and fine and long stems ensures a particularly efficient action of the anti-slip system.

According to a development of the invention, the at least one stem comprises a first lower conical section and at least one second upper conical section, in particular a conical tip section, of which the conicity (defined by its upper half angle) is greater than that of the first section, in particular being between 3° and 20°.

This at least double conicity ensures a particularly efficient action of the anti-slip system.

According to another development of the invention, the at least one stem comprises a first lower straight cylindrical section and at least one second upper conical section, in particular a conical tip section of which the conicity (defined by its upper half angle) is between 3° and 20°.

According to a preferred embodiment of the invention, the at least one stem has a free end in the form of a dome, in particular being spherical, and in particular with a radius of curvature of between 0.025 mm and 0.080 mm, particularly between 0.033 mm and 0.054 mm.

The axis of the at least one stem is preferably at an angle to the plane of the base of between 70° and 110°, in particular being substantially equal to 90°.

Preferably at least a section of the outer surface of the at least one stem; particularly a tip section of at least one stem, has an arithmetic roughness measured according to the ISO standard (Ra or mean roughness distance, that is to say the arithmetic average of all the data of the profile in a base length) of less than 400 nm, preferably less than 300 nm, more preferably less than 250 nm.

A web with stems is thus obtained which causes very limited impairment of the fabrics (in particular a knitted fabric of a woven fabric) with which it cooperates to produce an anti-slip action.

Preferably at least one section of the outer surface of the at least one stem, in particular a tip section of at least one stem, has a statistical roughness Rms of less than 450 nm, preferably less than 350 nm, more preferably less than 275 nm.

The present invention also relates to a unit according to claim 1, whereby developments are defined in the dependent claims 2, 3 and 7 to 14.

An embodiment of the invention will now be described solely by way of example by reference to the drawings, in which:

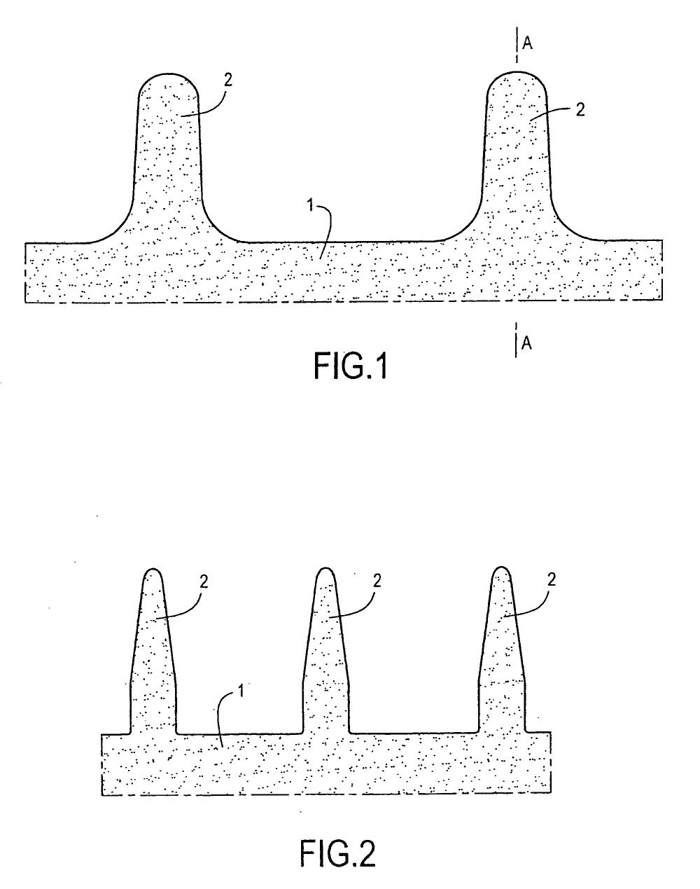

FIG. 1 is a side view of a web with stems according to the invention;

FIG. 2 is a view of a cross-section along the line A-A of FIG. 1;

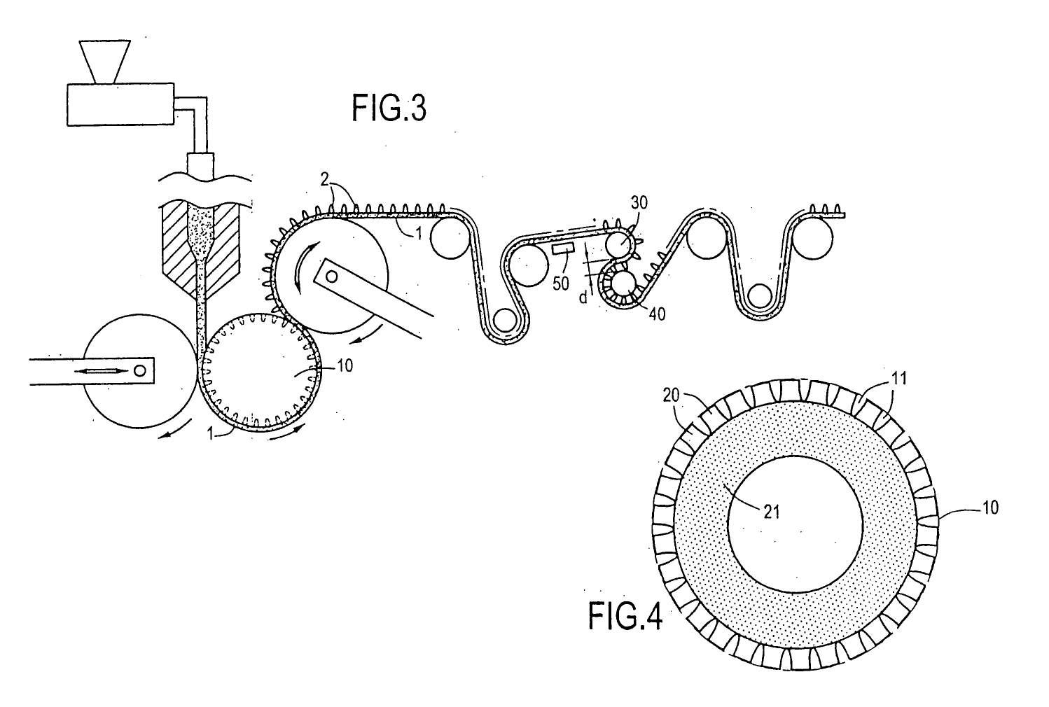

FIG. 3 is an overall view of a production installation according to the invention; and

FIG. 4 shows, schematically and in more detail, the moulding roller of the installation of FIG. 3.

One can see in FIG. 1 a section of a web with stems in the longitudinal direction (that is to say in the direction in which the strip is removed from the installation), comprising a strip or base 1 of a thermoplastic material, for example polyolefin, such as polyethylene or polypropylene for example or similar, from which stems 2 of the same material project, forming part of the strip 1.

The stems 2 are essentially cylindrical having a tip in the form of a dome. The stems 2 have a lower section of low conicity, the half angle at the tip being around 3° (this section could also be straight) and an upper conical section, of which the half angle at the tip is 15°. It could be between 3° and 20° for example. The stems are arranged in rows and columns. The spacing of a row, that is to say the distance between two successive stems in a row, can be chosen to be less than, equal to or greater than the spacing of the columns.

Measured in the direction of the columns as being the centre-to-centre distance between two successive stems, the spacing of the stems or inter-stem distance is at least equal to 0.23 mm in the cross direction (CD) and 0.23 mm in the machine direction (MD).

The height of the stem is preferably between 0.300 and 0.800 mm, particularly between 0.400 and 0.600 mm. In FIG. 1, it is 0.441 mm.

The width of the stems at the base is between 0.100 and 0.200 mm and in particular is 0.197 mm in the machine direction (direction of unrolling of the strip and direction in which the stretching is carried out) and is 0.180 mm in the transverse direction (CD), the cross-section of the stem being slightly oval here. The width of the stems can in particular be between 0.15 mm and 0.23 mm.

The ratio of the height to the width of the stem at its base is equal to 2.39. It is greater than 2. It is preferably greater than or equal to 3 or 4.

The thickness of the strip excluding the stems is 0.034 mm. It can be in particular between 0.02 mm and 0.15 mm, preferably between 0.03 and 0.09 mm.

FIG. 3 shows a production installation for a web with stems according to the invention. Liquid or melted thermoplastic material leaving a feed nozzle is passed to a moulding roller 10 comprising cavities 11 of cylindrical conical form, complementary to the form of the stems (such as those of FIGS. 1 and 2) which one wishes to obtain on leaving the installation. The material passes around the moulding roller, between the latter and a pressure roller which presses the melted material into the cavities in excess. After being removed from pressure and cooling, possibly by a supplementary cooling device, a web is obtained with a strip of a thickness corresponding essentially to the interstice between the two rollers and stems with a form corresponding substantially exactly to that of the cavities. Here, there is a thickness of the strip of around 0.2 mm and a total thickness (including the stem) of around 0.85 mm.

According to the invention, on leaving the roller, it is also provided to stretch the web with stems in one direction, particularly in the machine direction or unrolling direction of the web, whereby this is in accordance with so-called “short” stretching.

On leaving the moulding roller, the web with a stem thus formed passes to a first roller 30, so-called upstream roller, and a second roller 40, so-called downstream roller. The downstream roller is set in rotation at a speed greater than that of the upstream roller in order to thus stretch the web in its longitudinal direction. “Short” stretching is intended to mean that the distance d between the two rollers is small. It is chosen here to be equal to 0.9 mm. This corresponds essentially to the total initial thickness of the web with stems (that is to say the initial thickness of the web of 0.2 mm+stem height of 0.65 mm, namely 0.85 mm, whereby the difference of 0.05 mm is simply due to the fact that it must be possible to pass the web between the two rollers).

A heating device 50 is disposed upstream of the upstream roller 30 and preheats the back of the unrolled web in order to facilitate stretching.

The speed of the first roller is more than 2 to 4 times the speed of the second roller. The upstream roller 30 is heated to a temperature greater than or equal to the softening temperature (Vicat softening point) of the thermoplastic material and the downstream roller 40 is cold, that is so say below this softening temperature).

A particularly supple strip is thus obtained and with stems cooperating perfectly well with a fabric in order to ensure an anti-slip function. Besides, the variability of the width (CD) of the strip in the direction of its length (MD) is very small.

The moulding roller 10 is shown in section in FIG. 3, which is not to scale. The roller comprises an outer peripheral annular layer 20 of a material which can be etched by laser, particularly a rubber, particularly heat hardenable, or a plastic material or a metal. This layer is in contact with a lower layer 21, also annular and of a material which is sufficiently hard to withstand laser etching, for example being of stainless steel or copper. However, this material is realised so as to be permeable to air and impermeable to the usual thermoplastic material, whereby the material is so-called micro-porous material with open pores of a diameter of less than 0.050 mm, particularly between 0.01 and 0.04 mm. A material of this type is for example SIKA-R 100IS which is available from GKN Sinter Metals Filters under the reference Seamless Filter tube. A compression mould is used to produce it.

Thus, when producing the moulding roller, the cavities are formed by laser by etching the material of the outer layer until the lower layer is reached, where the etching is “stopped”. The lower layer will thus form a section of the bottom of the cavity and when the thermoplastic material is pressed into the cavity, even in the case of a very fine conical cavity, it is not prevented from reaching the bottom by an accumulation of air at the bottom, whereby the air is evacuated through the pores of the porous material. Very fine conical stems can thus be obtained.

In order to measure the roughness, an atomic force microscope can be used, Dimension 3000, which can be obtained from Digital Instrument.

When using a web with stems in a unit according to the invention, the stems of the web cooperate with the fabric by penetrating into the fabric, for example through being inserted into the gaps formed by the threads making up the fabric or by having their ends inserted between two threads which touch in case of very tight patterns, particularly in the case of woven fabric. An anti-slip effect is thus obtained between the web with stems on the one hand and the fabric on the other hand. On account of the stems being very fine, this penetration or insertion does not impair the fabric.

1. Anti-slip unit comprising a fabric, in particular a knitted fabric or a woven fabric, and a web with stems constituted by a base strip and at least one stem projecting from the strip and forming part thereof, in particular being of the same material as the strip, the at least one stem having a straight axis and a cross-section perpendicular to the straight axis which is constant or decreases from the base to the tip of the stem, characterised in that the at least one stem has a height measured along its axis and a width corresponding to its largest dimension measured parallel to the plane of the strip, and the ratio of the height of the stem to its width is at least greater than 2.

2. Anti-slip unit according to claim 1, characterised in that at least one tip section of the at least one stem is of conical form.

3. Unit according to claim 1, characterised in that the width of the at least one stem is between 0.05 mm and 0.250 mm.

4. Web with stems, constituted by a base strip and at least one stem projecting from the strip and forming part thereof, particularly being of the same material as the strip, the at least one stem having a straight axis and a cross-section perpendicular to the straight axis which is constant or decreases from the base to the tip of the stem, characterised in that the at least one stem has a height measured along its axis and a width corresponding to its largest dimension measured parallel to the plane of the strip, the width being between 0.071 mm and 0.185 mm and the ratio of the height of the stem to its width being at least greater than 2.

5. Web with stems, constituted by a base strip and at least one stem projecting from the strip and forming part thereof, particularly being of the same material as the strip, the at least one stem having a straight axis and a cross-section perpendicular to the straight axis which is constant or decreases from the base to the tip of the stem, is characterised in that the at least one stem has a height measured along its axis and a width corresponding to its largest dimension measured parallel to the plane of the strip, at least a tip section of the at least one stem is of conical form, and the ratio of the height of the stem to its width is at least greater than 2.

6. Web according to claim 5, characterised in that the width of the at least one stem is between 0.05 mm and 0.250 mm, particularly between 0.071 mm and 0.250 mm.

7. Unit according to claims 1, characterised in that the height of the at least one stem is between 0.2 mm and 0.8 mm.

8. Unit according to claim 1, characterised in that the strip has a thickness measured in the direction of the axis of the at least one stem of less than 0.1 mm.

9. Unit according to claim 1, characterised in that the at least one stem comprises a first lower conical section and at least one second upper conical section, particularly a conical tip section, of which the conicity (defined by its upper half angle) is greater than that of the first section, in particular being between 3° and 20°.

10. Unit according to claim 1, characterised in that the at least one stem comprises a first lower straight cylindrical section and at least a second upper conical section, particularly a conical tip section, of which the conicity (defined by its upper half angle) is between 3° and 20°.

11. Unit according to claims 1, characterised in that the at least one stem has a free end in the shape of a dome, particularly being spherical, and particularly with a radius of curvature between 0.025 mm and 0.080 mm.

12. Unit according to claim 1, characterised in that the axis of the at least one stem is at an angle to the plane of the base of between 70° and 110°.

13. Unit according to claim 1, characterised in that at least a section of the outer surface of the at least one stem, particularly a tip section of at least one stem, has an arithmetic roughness measured according to the ISO standard (Ra or mean roughness distance, that is to say the arithmetic average of all the data of the profile in a base length) of less than 400 nm.

14. Unit according to claim 1, characterised in that at least a section of the outer surface of the at least one stem, particularly a tip section of at least one stem, has a statistical roughness Rms of less than 450 nm.

15. Device for forming a web with stems, having a base from which stems project which are made of a thermoplastic material and having a straight axis and of which the cross-section in a plane parallel to that of the base is constant or decreases from the base to the tip of the stem, comprising a moulding roller, in which cavities are formed which are of a complementary form to that of the stems to be formed, is characterised in that the moulding roller, at least in part, particularly in the form of a layer, is made of a porous material with open pores, whereby the porosity is chosen so that air molecules can pass but molecules of thermoplastic material cannot, whereby the arrangement is such that said section of a porous material delimits at least in part each cavity, particularly a section of the bottom thereof.

16. Device according to claim 15, characterised in that the moulding roller comprises at least an upper layer and a lower layer, the upper layer being of a first material which can be hollowed out or machined, the second material being of a porous material, the cavities being formed by hollowing-out or machining in the first material until it is flush with the second material, which thus forms at least a section of the bottom.

17. Device according to claim 15, characterised in that the machining or hollowing-out is realised by laser etching with a periscopic finder, whereby the laser beam is controlled in such a way as to be deactivated when the surface of the second material is reached.

18. Device according to claim 15, characterised in that the porosity is chosen in such a way that the pores have an equivalent diameter (diameter of the circular cross-section of the same cross-section as that of the pores) of less than 50 micrometres.

19. Device according to claim 15, characterised in that the cavities are formed by machining of the material by micro piercing, particularly of a layer of plastic material, or by electro erosion, particularly of a layer of metallic material.

20. Device according to claim 15, characterised in that the device for forming a web with stems having, on leaving the moulding roller, a first thickness, a first length and a first width, comprises an upstream roller and a downstream roller which are arranged downstream of the moulding roller one after the other in the direction of the length (machine direction), the downstream roller having a rotating speed greater than that of the upstream roller, the distance between the two rollers being small, in such a way that the web, on leaving the device, has a second thickness which is smaller than the first thickness and a second length which is greater than the first length.

21. Web according to one claim 4, characterised in that the height of the at least one stem is between 0.2 mm and 0.8 mm.

22. Web according to claim 4, characterised in that the strip has a thickness measured in the direction of the axis of the at least one stem of less than 0.1 mm.

23. Web according to claim 4, characterised in that the at least one stem comprises a first lower conical section and at least one second upper conical section, particularly a conical tip section, of which the conicity (defined by its upper half angle) is greater than that of the first section, in particular being between 3° and 20°.

24. Web according to claim 4, characterised in that the at least one stem comprises a first lower straight cylindrical section and at least a second upper conical section, particularly a conical tip section, of which the conicity (defined by its upper half angle) is between 3° and 20°.

25. Web according to claim 4, characterised in that the at least one stem has a free end in the shape of a dome, particularly being spherical, and particularly with a radius of curvature between 0.025 mm and 0.080 mm.

26. Web according to claim 4, characterised in that the axis of the at least one stem is at an angle to the plane of the base of between 70° and 110°.

27. Web according to claim 4, characterised in that at least a section of the outer surface of the at least one stem, particularly a tip section of at least one stem, has an arithmetic roughness measured according to the ISO standard (Ra or mean roughness distance, that is to say the arithmetic average of all the data of the profile in a base length) of less than 400 nm.

28. Web according to claim 4, characterised in that at least a section of the outer surface of the at least one stem, particularly a tip section of at least one stem, has a statistical roughness Rms of less than 450 nm.

29. Web according to one claim 5, characterised in that the height of the at least one stem is between 0.2 mm and 0.8 mm.

30. Web according to claim 5, characterised in that the strip has a thickness measured in the direction of the axis of the at least one stem of less than 0.1 mm.

31. Web according to claim 5, characterised in that the at least one stem comprises a first lower conical section and at least one second upper conical section, particularly a conical tip section, of which the conicity (defined by its upper half angle) is greater than that of the first section, in particular being between 3° and 20°.

32. Web according to claim 5, characterised in that the at least one stem comprises a first lower straight cylindrical section and at least a second upper conical section, particularly a conical tip section, of which the conicity (defined by its upper half angle) is between 3° and 20°.

33. Web according to claim 5, characterised in that the at least one stem has a free end in the shape of a dome, particularly being spherical, and particularly with a radius of curvature between 0.025 mm and 0.080 mm.

34. Web according to claim 5, characterised in that the axis of the at least one stem is at an angle to the plane of the base of between 70° and 110°.

35. Web according to claim 5, characterised in that at least a section of the outer surface of the at least one stem, particularly a tip section of at least one stem, has an arithmetic roughness measured according to the ISO standard (Ra or mean roughness distance, that is to say the arithmetic average of all the data of the profile in a base length) of less than 400 nm.

36. Web according to claim 5, characterised in that at least a section of the outer surface of the at least one stem, particularly a tip section of at least one stem, has a statistical roughness Rms of less than 450 nm.
